(19) United States
(12) Patent Application Publication
(10) Pub. No.: US 2026/0065252 A1
(43) Pub. Date: Mar. 5, 2026

(54) SYSTEMS AND METHODS FOR POINT-OF-SALE RESOURCE TRANSFERS VIA A TRANSFER SERVICE

(71) Applicant: Wells Fargo Bank, N.A., San Francisco, CA (US)

(72) Inventor: Caleb Jordan Parker, San Francisco, CA (US)

(73) Assignee: Wells Fargo Bank, N.A., San Francisco, CA (US)

(21) Appl. No.: 18/823,471

(22) Filed: Sep. 3, 2024

(51) Int. Cl. G06Q 20/20

(52) U.S. Cl. CPC G06Q 20/206; G06Q 20/204

(57) ABSTRACT

A method includes: receiving transfer service information associated with the merchant, the transfer service information including a merchant identifier for a merchant and associated with a transfer service provided by a transfer service entity; receiving transaction information associated with a transaction at a point of sale from a merchant computing system of the merchant; providing the transfer service information and the transaction information to a customer device of a customer during the transaction at the point of sale; receiving a notification indicating that a transfer of resources corresponding to the transaction has been completed; and in response to verifying that the transaction has been completed, performing a transaction completion action.

### TECHNICAL FIELD

The present disclosure relates to systems and methods for enabling transaction processing devices to generate and provide user interfaces and/or transmit information configured to allow for point-of-sale resource transfers via a transfer service to be securely conducted and verified.

### BACKGROUND

Many small businesses utilize third-party transaction processing devices (e.g., Square®) as their point-of-sale system. These third-party transaction processing devices and corresponding transaction processing entities provide necessary hardware for card readers as well as additional hardware and/or software for other operations, such as providing customer receipts. These third-party transaction processing devices have traditionally allowed for customers to complete transactions using debit or credit cards and/or tap-to-pay functionality (e.g., by accessing stored mobile wallet payment card information from customer devices). But, traditional third-party transaction processing devices have had limited compatibility with a variety of resource transfer options that could potentially be used to complete transactions.

### SUMMARY

One embodiment relates to a method. The method includes receiving, by a transaction processing device associated with a point of sale of a merchant, transfer service information associated with the merchant, the transfer service information including a merchant identifier for the merchant and associated with a transfer service provided by a transfer service entity. The method further includes receiving, by the transaction processing device, transaction information associated with a transaction at the point of sale from a merchant computing system of the merchant, the transaction information including a transaction identifier identifying the transaction. The method further includes providing, by the transaction processing device, the transfer service information and the transaction information to a customer device of a customer during the transaction at the point of sale. The method further includes receiving, by the transaction processing device, a notification indicating that a transfer of resources corresponding to the transaction has been completed, the notification including a confirmation transaction identifier. The method further includes verifying, by the transaction processing device, that the transaction has been completed based on the transaction identifier matching the confirmation transaction identifier. The method further includes, in response to verifying that the transaction has been completed, performing, by the transaction processing device, a transaction completion action.

Another embodiment relates to a method. The method includes providing, by a provider computing system of a provider, a graphical user interface including transfer service information associated with a merchant to a transaction processing device associated with a point of sale of the merchant, the transfer service information including a merchant identifier for the merchant and associated with a transfer service provided by a transfer service entity, the graphical user interface including the transfer service information embedded within a scannable code. The method further includes receiving, by the provider computing system, the transfer service information and transaction information from a customer device of a customer, the transaction information corresponding to a transaction using the transaction processing device at the point of sale of the merchant. The method further includes, in response to receiving the transfer service information and the transaction information, initiating, by the provider computing system, a transfer of resources from a customer account of the customer to a merchant account of the merchant based on the merchant identifier and the transaction information.

Yet another embodiment relates to a transaction processing device. The transaction processing device includes one or more processing circuits including one or more processors and one or more memories having instructions stored thereon that, when executed by the one or more processors, cause the one or more processing circuits to receive transfer service information of a merchant associated with the transaction processing device, the transfer service information including a merchant identifier for the merchant and associated with a transfer service provided by a transfer service entity. The instructions further cause the one or more processing circuits to receive transaction information associated with a transaction at a point of sale from a merchant computing system of the merchant, the transaction information including a transaction identifier identifying the transaction. The instructions further cause the one or more processing circuits to provide a customer with a plurality of selectable transaction options including a selectable transaction option that is selectable by the customer to utilize the transfer service to complete the transaction. The instructions further cause the one or more processing circuits to, in response to receiving a selection of the selectable transaction option, provide the transfer service information and the transaction information to a customer device of the customer. The instructions further cause the one or more processing circuits to receive a notification indicating that a transfer of resources corresponding to the transaction has been completed, the notification including a confirmation transaction identifier. The instructions further cause the one or more processing circuits to verify that the transaction has been completed based on the transaction identifier matching the confirmation transaction identifier.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

FIG. 1 is a block diagram of a computing environment for enabling and conducting resource transfers via a transfer service using a transaction processing device at a point of sale of a merchant, according to an example embodiment.

FIG. 2 is flow diagram of a method for integrating transfer service functionality into a transaction processing device at a point of sale associated with a merchant, according to an example embodiment.

FIG. 3 is flow diagram of a method for utilizing a transfer service to complete a transaction at a point of sale associated with a merchant using a transaction processing device, according to an example embodiment.

FIG. 4 is a graphical user interface providing a plurality of selectable transaction options during a transaction, according to an example embodiment.

FIG. 5 is a graphical user interface providing a scannable code for scanning for completing a transaction using a transfer service, according to an example embodiment.

FIG. 6 is a graphical user interface configured to allow a customer to confirm a transaction using a transfer service, according to an example embodiment.

### DETAILED DESCRIPTION

Referring generally to the Figures, systems, computer-readable media, and methods for enabling and conducting resource transfers via a transfer service using a transaction processing device at a point of sale of a merchant are disclosed according to various embodiments herein.

In accordance with the systems, computer-readable media, and methods described herein, a customer may initiate a transaction at a point of sale of a merchant, and a merchant computing system may send various transaction details related to the transaction to a transaction processing device at the point of sale to enable the transaction processing device to complete the transaction. The transaction processing device is a payment terminal (e.g., a credit card machine, card reader, PIN pad, or other transaction completion interface). The transaction processing device may have stored a merchant identifier associated with the merchant that is registered with a transfer service (e.g., Zelle®, and in turn have a transfer tag or identifier associated with the transfer service, such as Zelle®) that was received during a transfer service integration process. The transaction processing device may thus allow the customer to select payment utilizing the transfer service to complete the transaction.

In one example, upon selecting the transfer service as the payment methodology, a customer device associated with the customer may either scan a code on the transaction processing device (e.g., displayed on a display of the transaction processing device) to receive various information relating to the transaction or receive via a transmission (e.g., Bluetooth, NFC, etc.) from the transaction processing device including the various information relating to the transaction. The information that is obtained and/or received may include, but is not limited to, the merchant identifier and various transaction details (e.g., time of transaction, purchased product and/or service identifier, transaction location, customer identifier, etc.). The various information may allow the customer device to initiate a transfer of resources (e.g., currency such as the U.S. dollar) to the merchant corresponding to the transaction via the transfer service. Specifically, the customer device may send a request to a transfer service computing system associated with the transfer service to initiate the transfer of resources. The transfer service computing system may then initiate the transfer and notify the transaction processing device upon completion of the transfer. Upon receiving confirmation from the transfer service computing system, the transaction processing device can perform various transaction completion actions, such as, for example, providing a receipt to the customer (e.g., a physical receipt or an electronic copy of a receipt) and/or displaying various transaction completion information.

Beneficially, the systems and methods described herein provide an integrated platform that allows merchants (e.g., small businesses) to take advantage of hardware capabilities of transaction processing devices (e.g., card readers, NFC devices) that enable a variety of traditionally offered payment methods, while further providing the option to use a transfer service, such as Zelle®, to complete transactions at a merchant point of sale. Specifically, the systems, computer-readable media, and methods described herein provide unique connections between disparate computing systems that allow for the transaction processing device to securely provide transfer service and transaction information necessary to initiate a transfer service transfer of resources, and to receive confirmation from the transfer service that the transfer has been completed to verify that the transaction has been successfully completed.

Accordingly, the systems, methods, and computer-readable media described herein solve the technical problem of allowing for transfer service transfers to be securely utilized in point-of-sale transactions by creating a unique and integrated platform that allows for confirmation transaction information to be relayed back from the transfer service to the transaction processing device (e.g., the point-of-sale device) in real-time or near real-time.

Further, because the transaction processing device communicates various transaction details (e.g., specific items and/or services purchased) that are not normally included in or available within transfer data associated with resource transfers using the transfer service, the transfer service entity providing the transfer service is beneficially enabled to monitor and track purchase information (e.g., purchase type categories, purchase amounts in each purchase type category) for its customers that has not traditionally been available.

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

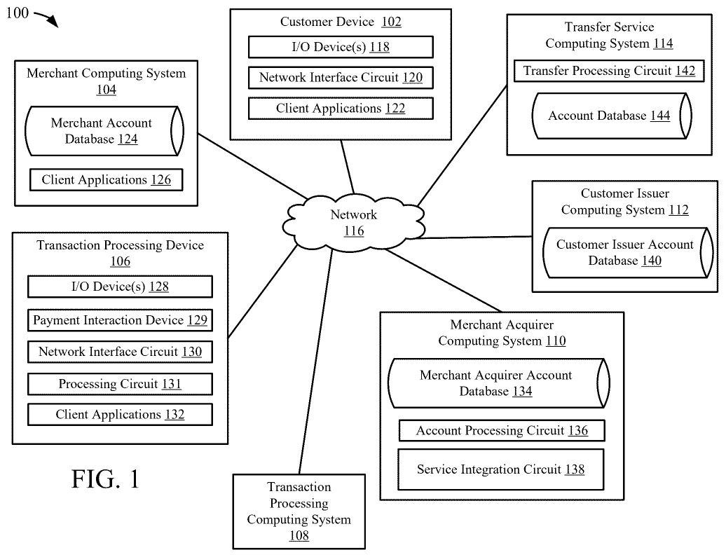

FIG. 1 is a diagram of a computing environment 100 that enables transaction processing devices associated with third-party transaction processing entities (e.g., Clover®, Square®) to facilitate point-of-sale resource transfers (e.g., a monetary resource transfer transaction at a point of sale) using a transfer service (e.g., Zelle®). As shown, the computing environment 100 includes a customer device 102, a merchant computing system 104, a transaction processing device 106, a transaction processing computing system 108, a merchant acquirer computing system 110, a customer issuer computing system 112, and a transfer service computing system 114. The various components of the computing environment are in communication with each other and are connected by a network 116.

Although the various systems and devices are shown in FIG. 1 as being singular, it will be understood that, in some instances, the computing environment 100 may include one or multiple of any of the various illustrated systems and/or devices, as desired for a given application. Similarly, while the following descriptions of the various systems and devices are largely provided in terms of single systems or devices, it will be appreciated that these descriptions are similarly applicable to any additional corresponding systems and/or devices (e.g., additional merchant computing systems 104, additional customer devices 102, and so on).

The customer device 102 is owned, operated, controlled, managed, and/or otherwise associated with a customer who also may be referred to as a user herein (e.g., a customer making a purchase at a merchant point of sale associated with the merchant computing system 104). In some embodiments, the customer device 102 may be or may comprise, for example, a desktop or laptop computer (e.g., a tablet computer), a smartphone, a wearable device (e.g., a smartwatch), a personal digital assistant, and/or any other suitable computing device. In the example shown, the customer device 102 is a mobile device (e.g., a smartphone).

In some embodiments, the customer device 102 includes one or more I/O devices 118, a network interface circuit 120, and one or more client applications 122. While the term “I/O” is used, it should be understood that the I/O devices 118 may be input-only devices, output-only devices, and/or a combination of input and output devices. In some instances, the I/O devices 118 include various devices that provide perceptible outputs (such as display devices with display screens and/or light sources for visually-perceptible elements, an audio speaker for audible elements, and haptics or vibration devices for perceptible signaling via touch, etc.), that capture ambient sights and sounds (such as digital cameras, microphones, etc.), and/or that allow the customer to provide inputs (such as a touchscreen display, stylus, keyboard, force sensor for sensing pressure on a display screen, etc.). In some instances, the I/O devices 118 further comprise one or more other types of user interfaces (devices or components that interface with the customer), as desired for a given application.

The network interface circuit 120 includes, for example, program logic and various devices (e.g., transceivers, etc.) that connect the customer device 102 to the network 116. The network interface circuit 120 facilitates secure communications between the customer device 102 and various other components of the computing environment 100. The network interface circuit 120 also facilitates communication with other entities, such as other banks, settlement systems, and so on.

In some instances, the customer device 102 stores in computer memory, and executes (“runs”) using one or more processors, various client applications 122, such as an Internet browser presenting websites and/or applications provided or authorized by entities implementing or administering any of the computing systems in computing environment 100 to enable the customer to perform or otherwise interact with various methods and operations described herein.

In the example shown, the client applications 122 comprise a customer issuer client application (e.g., a financial institution banking application) provided by and at least partly supported by the customer issuer computing system 112. For example, the customer issuer client application may allow the customer to access a variety of functionalities associated with a bank account of the customer (e.g., checking account balances, making withdrawals, making deposits, performing money transfers). Accordingly, the customer issuer client application may be in communication with the customer issuer computing system 112 (e.g., via an application programming interface (API) and/or via the network 116) to provide various functionality provided by the customer issuer computing system 112 via the client application 122.

In some instances, the client applications 122 may comprise a merchant client application provided by and at least partly supported by the merchant computing system 104. For example, the merchant client application may allow the customer to access a variety of functionalities associated with the merchant computing system 104. For example, the merchant client application may allow for the customer to view various products for sale, make online purchases via the app, obtain product information). Accordingly, the customer issuer client application may be in communication with the merchant computing system 104 (e.g., via an API and/or via the network 116) to provide various functionality provided by the merchant computing system 104 via the client application 122.

In some instances, the client applications 122 comprise a transfer service client application provided by and at least partly supported by the transfer service computing system 114. For example, the transfer service client application may allow the customer to perform or otherwise utilize one or more services (e.g., a transfer service) provided by the transfer service computing system 114. Accordingly, the transfer service client application may be in communication with the transfer service computing system 114 (e.g., via an application programming interface (API) and/or via the network 116) to provide various functionality provided by the transfer service computing system 114 via the client application 122.

In some instances, the client application 122 may additionally be coupled to various components within the computing environment 100 (e.g., the merchant computing system 104, the merchant acquirer computing system 110, the customer issuer computing system 112) via one or more application programming interfaces (APIs) and/or software development kits (SDKs) to integrate one or more features or services provided by the various components to enable the various methods and operations described herein.

In some embodiments, the merchant computing system 104 is controlled by, managed by, owned by, and/or otherwise associated with a merchant (e.g., a product and/or service provider), such as a point-of-sale merchant or service provider (e.g., a physical retail store, a physical service provider location) and/or any other commercial or individual seller of goods, services, and/or any other tangible or intangible articles of commerce. In some embodiments, the merchant computing system 104 may, for example, comprise one or more servers, each with one or more processing circuits including one or more processors configured to execute instructions stored in one or more memory devices, send and receive data stored in the one or more memory devices, and perform other operations to implement the operations described herein associated with certain logic and/or processes depicted in the figures. In some instances, the merchant computing system 104 may comprise and/or have various other devices communicably coupled thereto, such as, for example, desktop or laptop computers (e.g., tablet computers), smartphones, wearable devices (e.g., smartwatches), and/or other suitable devices.

As shown in FIG. 1, the merchant computing system 104 includes a merchant account database 124. The merchant account database 124 may be a repository for data that stores various customer account information, customer preferences, customer account access credentials, customer payment method history, and various customer identifying information that is tied to the merchant (e.g., via a transaction history between the customer and the particular merchant). In some instances, the merchant computing system 104 may be configured to retrieve and transmit various customer data stored within the merchant account database 124 to various components within the computing environment 100 to enable the various methods, functions, and processes described herein.

The merchant computing system 104 may store in one or more computer memory, and execute (“runs”) using one or more processors, various client applications 126, such as an Internet browser presenting websites and/or applications provided or authorized by entities implementing or administering any of the computing systems in computing environment 100 to enable the merchant (e.g., a user of the merchant computing system 104) to perform or otherwise interact with various methods and operations described herein.

For example, in some instances, the client applications 126 comprise a merchant acquirer client application provided by and at least partly supported by the merchant acquirer computing system 110. For example, the merchant acquirer client application may allow the merchant to access a variety of functionalities associated with a bank account of the merchant (e.g., checking account balances, making withdrawals, making deposits, performing money transfers). Accordingly, the merchant acquirer client application may be in communication with the merchant acquirer computing system 110 (e.g., via an application programming interface (API) and/or via the network 116) to provide various functionality provided by the merchant acquirer computing system 110 via the client application 126.

In some instances, the client applications 126 comprise a transaction processing client application provided by and at least partly supported by the transaction processing computing system 108 and configured to allow the merchant to modify one or more functionalities of the transaction processing device 106. For example, the transaction processing client application may allow the merchant to access a variety of functionalities associated with the transaction processing device 106 (e.g., updating interfaces, transmitting transaction details between the merchant computing system 104 and the transaction processing device 106). Accordingly, the transaction processing client application may be in communication with the transaction processing device 106 and/or the transaction processing computing system 108 (e.g., via an application programming interface (API) and/or via the network 116) to access, modify, and/or otherwise interact with various functionality provided by the transaction processing device 106 via the client application 126.

In some instances, the client applications 126 comprise a transfer service client application provided by and at least partly supported by the transfer service computing system 114 and configured to allow the merchant to perform or otherwise utilize one or more services (e.g., a transfer service) provided by the transfer service computing system 114. For example, the transfer service client application may similarly allow the merchant to perform or otherwise utilize one or more services (e.g., a transfer service) provided by the transfer service computing system 114 (e.g., performing transfers, receiving transfer verifications). Accordingly, the transfer service client application may be in communication with the transfer service computing system 114 (e.g., via an application programming interface (API) and/or via the network 116) to provide various functionality provided by the transfer service computing system 114 via the client application 126.

In some instances, the client applications 126 may additionally be coupled to various components within the computing environment 100 (e.g., the customer device 102, the transaction processing device 106, the transaction processing computing system 108, the merchant acquirer computing system 110, the customer issuer computing system 112) via one or more application programming interfaces (APIs) and/or software development kits (SDKs) to integrate one or more features or services provided by the various components to enable the various methods and operations described herein.

Although not specifically shown, it will be appreciated that the merchant computing system 104 may similarly include various I/O devices (e.g., similar to I/O device(s) 118), a network interface circuit (e.g., similar to the network interface circuit 120), additional client applications, additional databases, an account processing circuit (e.g., similar to the account processing circuit 136 of the merchant acquirer computing system 110), and other circuits in the same or similar manner to the other components of computing environment 100.

In some instances, the transaction processing device 106 is owned, operated, controlled, managed, and/or otherwise associated with a transaction processing entity (e.g., Clover®, Square®) associated with the transaction processing computing system 108 and configured to process a variety of transactions (e.g., debit card transactions, credit card transactions, tap-to-pay transactions using a mobile device). In some instances, the transaction processing device 106 is owned, operated, leased, rented, controlled, managed, and/or otherwise associated with the merchant (e.g., the merchant may purchase the transaction processing device 106 from the transaction processing entity). In some instances, the transaction processing device 106 may be a point-of-sale device or point-of-sale system that is integrated within or otherwise connected to the merchant computing system 104.

For example, the transaction processing device 106 may be or may comprise a card terminal interface device configured to receive swipes, dips, and/or taps from various payment cards and/or other payment devices (e.g., a mobile wallet device with tap-to-pay functionality). As will be described herein, in some instances, the transaction processing device 106 may be configured or structured to enable the transfer service resource transfers by (i) providing a customer with various transfer information (e.g., merchant transfer service identifier, a transaction identifier, a transfer amount) via a display or a communication with the customer device 102 and (ii) receiving a secure confirmation that the transfer has been completed from at least one of the merchant acquirer computing system 110, the customer issuer computing system 112, or the transfer service computing system 114. Beneficially, and as described herein, the transaction processing device 106 is additionally configured to process and/or otherwise facilitate resource transfers (e.g., transactions) utilizing a transfer service (e.g., Zelle®) provided via the transfer service computing system 114.

The transaction processing entity is an entity configured to capture, process, and/or store a variety of transaction information and transmit the transaction information over appropriate payment rails (e.g., Visa®, Mastercard®) to initiate transactions. As will be described herein, the transaction processing entity may be in communication with and/or otherwise affiliated with a transfer service entity (e.g., Zelle®) to allow for the transaction processing device 106 to complete various transactions using the transfer service. For example, the transaction processing entity may provide the transaction processing device 106 (and other similar transaction processing devices) to various merchants to allow the merchants to conduct various transactions.

In some instances, a variety of different devices may be configured for use as the transaction processing device 106. For example, in some instances, a transaction processing application and/or various hardware accessories (e.g., card readers, short-range transceiver (an NFC device), magstripe reader, EMV reader, etc.) may be provided by the transaction processing entity (e.g., via the transaction processing computing system 108) to a variety of devices to allow for the devices to perform the transaction processing functionality of the transaction processing device 106. For example, in some instances, any of a desktop or laptop computer (e.g., a tablet computer), a smartphone, a wearable device (e.g., a smartwatch), a personal digital assistant, and/or any other suitable computing device may be configured for use as the transaction processing device 106, as desired for a given application. Accordingly, in some instances, the transaction processing device 106 may be owned, operated, controlled, managed, and/or otherwise associated with the merchant and/or various other entities.

In some embodiments, the transaction processing device 106 includes one or more I/O devices 128, one or more payment interaction devices 129, a network interface circuit 130, one or more processing circuits 131, and one or more client applications 132. Similarly, while the term “I/O” is used, it should be understood that the I/O devices 128 may be input-only devices, output-only devices, and/or a combination of input and output devices. In some instances, the I/O devices 128 include various devices that provide perceptible outputs (such as display devices with display screens and/or light sources for visually-perceptible elements, an audio speaker for audible elements, and haptics or vibration devices for perceptible signaling via touch, etc.), that capture ambient sights and sounds (such as digital cameras, microphones, etc.), and/or that allow the customer to provide inputs (such as a touchscreen display, stylus, keyboard, force sensor for sensing pressure on a display screen, etc.). In some instances, the I/O devices 128 further comprise one or more other types of user interfaces (devices or components that interface with the customer), as desired for a given application.

In some instances, the payment interaction devices 129 include or comprise one or more hardware accessories configured to allow for various transaction information (e.g., payment information, credit or debit card numbers, customer information) to be provided to the transaction processing device 106 during a transaction. For example, the payment interaction devices 129 may include one or more of a card reader, a short-range transceiver (an NFC device), a magstripe reader, an EMV reader, etc.

The network interface circuit 130 includes, for example, program logic and various devices (e.g., transceivers, etc.) that connect the transaction processing device 106 to the network 116. The network interface circuit 130 facilitates secure communications between the transaction processing device 106 and various other components of the computing environment 100. The network interface circuit 120 also facilitates communication with other entities, such as other banks, settlement systems, payment card networks, and so on.

The one or more processing circuits 131 are structured or configured to perform a variety of functionalities or operations to enable various transactions and to generate user interfaces and facilitate secure transactions utilizing the transfer service provided by the transfer service entity associated with the transfer service computing system 114, as further described below.

In some instances, the transaction processing device 106 stores in computer memory, and executes (“runs”) using one or more processors, various client applications 132, such as an Internet browser presenting websites and/or applications provided or authorized by entities implementing or administering any of the computing systems in computing environment 100 to enable the customer to perform or otherwise interact with various methods and operations described herein.

For example, in some instances, the client applications 132 comprise a transaction processing client application provided by and at least partly supported by the transaction processing computing system 108. In some instances, the client applications 132 may comprise a transfer service client application provided by and at least partly supported by the transfer service computing system 114. In some instances, the client applications 132 may comprise a transfer service client application provided by and at least partly supported by the transfer service computing system 114 and configured to allow the transaction processing device 106 to perform or otherwise utilize one or more services (e.g., a transfer service) provided by the transfer service computing system 114. In some instances, the client applications 132 may comprise a provide client application provided by and at least partly supported by either of the merchant acquirer computing system 110 and/or the transfer service computing system 114 to allow for the transaction processing device 106 to incorporate functionality provided by the corresponding provider.

In some instances, the client application 132 may additionally be coupled to various components within the computing environment 100 (e.g., the merchant computing system 104, the merchant acquirer computing system 110, the customer issuer computing system 112) via one or more application programming interfaces (APIs) and/or software development kits (SDKs) to integrate one or more features or services provided by the various components to enable the various methods and operations described herein.

It should be appreciated that the various client applications described herein (e.g., the client applications 122, the client applications 126, the client applications 132) are structured to provide the user with access to various services offered by the various components of the environment 100. In some embodiments, the various client applications are hard coded onto the memory of their respective system or device (e.g., the customer device 102, the merchant computing system 104, the transaction processing device 106). In some embodiments, the various client applications are web-based interface applications, where the user has to log onto or access the web-based interface before usage, and these applications are supported by a separate computing system comprising one or more servers, processors, network interface circuits, or the like (e.g., the transaction processing computing system 108, the merchant acquirer computing system 110, the customer issuer computing system 112, the transfer service computing system 114), that transmit the applications for use to the corresponding systems or devices.

The transaction processing device 106 is communicably coupled with the transaction processing computing system 108, which is similarly owned, operated, controlled, managed, and/or otherwise associated with the transaction processing entity. For example, in some instances, the transaction processing device 106 is configured to transmit various transaction information from the point of sale to the transaction processing computing system 108 to be used to process various transactions conducted at the merchant.

Although not specifically shown, it will be appreciated that the transaction processing computing system 108 may similarly include various I/O devices (e.g., similar to I/O device(s) 118 and/or I/O device(s) 128)), a network interface circuit (e.g., similar to the network interface circuit 120 and/or network interface circuit 130), client applications (e.g., similar to client applications 122, the client applications 126, and/or the client applications 132), and other circuits in the same or similar manner to the other components of computing environment 100.

The merchant acquirer computing system 110 is owned by, associated with, or otherwise operated by a first provider institution (e.g., a bank or other financial institution) that maintains one or more accounts held by various customers (e.g., the merchant associated with the merchant computing system 104), such as demand deposit accounts, credit card accounts, receivables accounts, and so on. In some instances, the first provider institution may act as an acquirer in a transaction process. However, it will be appreciated that, in some instances, the first provider institution may act as an issuer in a transaction process.

In some instances, the merchant acquirer computing system 110 may, for example, comprise one or more servers, each with one or more processing circuits having one or more processors configured to execute instructions stored in one or more memory devices to send and receive data stored in the one or more memory devices and perform other operations to implement the methods described herein associated with logic or processes shown in the figures. In some instances, the merchant acquirer computing system 110 may comprise and/or have various other devices communicably coupled thereto, such as, for example, desktop or laptop computers (e.g., tablet computers), smartphones, wearable devices (e.g., smartwatches), and/or other suitable devices.

The merchant acquirer computing system 110 includes a merchant acquirer account database 134 that is structured or configured to retrievably store account information associated with various accounts (e.g., an account of the merchant) held or otherwise maintained by the merchant acquirer institution on behalf of its customers (e.g., the merchant). In some instances, the account information includes both customer information and account information pertaining to a given account. For example, in some instances, the customer information may include a name, a phone number, an e-mail address, a transfer service identifier, a physical address, a username, etc., of the customer (e.g., the merchant) associated with the account.

In some instances, the merchant acquirer account database 134 further stores information pertaining to various transaction processing devices (e.g., transaction processing device 106) and/or transfer service accounts (e.g., accounts held by the transfer service entity associated with the transfer service computing system 114) to allow for the merchant offer point-of-sale resource transfers via the transfer service using the transaction processing device 106, as will be described in detail below.

The merchant acquirer computing system 110 further includes an account processing circuit 136 that is structured or configured to perform a variety of functionalities or operations to enable various customer activities in connection with customer account information stored within the merchant acquirer account database 134. For example, in some instances, the account processing circuit 136 performs various functionalities to enable account opening and/or closing actions, various account transactions (e.g., debit transactions, credit transactions), and/or a variety of other services associated with and/or provided by the provider.

The merchant acquirer computing system 110 further includes a service integration circuit 138 that is structured or configured to perform a variety of functionalities or operations to enable the various service integration functionalities described herein (e.g., integrating or otherwise linking the merchant's account with the merchant acquirer with accounts held by the merchant with the transaction processing entity and/or the transfer service entity). For example, in some instances, the service integration circuit 138 is configured to receive various account information associated with one or more of the merchant acquirer's customers (e.g., the merchant) and to store the account information within the merchant acquirer account database 134.

The account information may include, for example, account identifiers associated with the customer's account (e.g., the merchant's account) with the merchant acquirer, the transaction processing entity, and/or the transfer service. The account information may further include one or more login credentials configured to provide access to the customer's account with the merchant acquirer, the transaction processing entity, and/or the transfer service. Accordingly, in some instances, the service integration circuit 138 is configured to link the customer's account with the merchant acquirer (e.g., the merchant's account) with various third-party accounts of the customer (e.g., the customer's accounts with the transaction processing entity and/or the transfer service) by creating and storing associations between the various accounts within the merchant acquirer account database 134. In some instances, the service integration circuit 138 is further configured to utilize the various customer account information to provide selective access (e.g., via API calls and/or other suitable communications) to various features and functionalities of the customer's third-party accounts to allow for the customer to perform the various functionalities herein (e.g., via one of the client applications 122, the client applications 126, or the client applications 132), as will be described below.

In some instances, the service integration circuit 138 is further configured to generate, maintain, and/or otherwise provide service integration applications or application programming interfaces (APIs) and/or payment method incentive applications or APIs to the customer device 102, the transaction processing device 106, the transaction processing computing system 108, the transfer service computing system 114, and/or the customer issuer computing system 112 to enable various displays, information input, and other functionalities, as will be described in detail below.

Although not specifically shown, it will be appreciated that the merchant acquirer computing system 110 may similarly include various I/O devices (e.g., similar to I/O device(s) 118), a network interface circuit (e.g., similar to the network interface circuit 120), client applications (e.g., similar to client applications 122 or the client applications 126), and other circuits in the same or similar manner to the other components of computing environment 100. For example, in some instances, the merchant acquirer computing system 110 may include a network interface circuit having user interface program logic configured to generate and present application pages, web pages, and/or various other data to users accessing the merchant acquirer computing system 110 over the network 116.

The customer issuer computing system 112 is owned by, associated with, or otherwise operated by a second provider institution (e.g., a bank or other financial institution) that maintains one or more accounts held by various customers (e.g., the customer associated with the customer device 102), such as demand deposit accounts, credit card accounts, receivables accounts, mortgages, and so on. While the customer issuer computing system 112 is shown as being separate and distinct from the merchant acquirer computing system 110, it will be appreciated that, in some instances, the same provider institution may service both the merchant and the customer, such that the merchant acquirer computing system 110 and the customer issuer computing system 112 may comprise a single provider computing system associated with a single provider institution. Accordingly, in these instances, the single provider institution may act as both an acquirer and as an issuer in a transaction process. Alternatively, in the instances that the customer issuer computing system 112 is separate and distinct from the merchant acquirer computing system 110 (as shown in FIG. 1), the customer issuer computing system 112 may include similar components to the merchant acquirer computing system 110 described above.

For example, in some instances, the customer issuer computing system 112 may similarly comprise one or more servers, each with one or more processing circuits having one or more processors configured to execute instructions stored in one or more memory devices to send and receive data stored in the one or more memory devices and perform other operations to implement the methods described herein associated with logic or processes shown in the figures. In some instances, the customer issuer computing system 112 may further similarly comprise and/or have various other devices communicably coupled thereto, such as, for example, desktop or laptop computers (e.g., tablet computers), smartphones, wearable devices (e.g., smartwatches), and/or other suitable devices.

The customer issuer computing system 112 includes a customer issuer account database 140 that is similar to the merchant acquirer account database 134 described above. For example, the customer issuer account database 140 is similarly structured or configured to retrievably store customer account information associated with various customer accounts (e.g., an account of the customer) held or otherwise maintained by the customer issuer institution on behalf of its customers. In some instances, the customer account information includes similar customer information and account information pertaining to customer accounts as described above, with reference to the merchant acquirer account database 134, but that are specific to the accounts and customers of the provider entity associated with the customer issuer computing system 112 (e.g., account numbers, customer address, customer name, customer phone number, balance information, transaction history information, etc.).

Although not specifically shown, in some instances, the customer issuer computing system 112 may include an account processing circuit (e.g., similar to the account processing circuit 136) and a service integration circuit (e.g., similar to the service integration circuit 138) to allow for the customer issuer computing system 112 to perform the various functions described herein, with respect to the merchant acquirer computing system 110.

Further, although also not specifically shown, it will be appreciated that the customer issuer computing system 112 may similarly include various I/O devices (e.g., similar to I/O device(s) 118), a network interface circuit (e.g., similar to the network interface circuit 120), client applications (e.g., similar to client applications 122 or client applications 126), and various other circuits in the same or similar manner to the other components of computing environment 100. For example, in some instances, the customer issuer computing system 112 may include a network interface circuit having user interface program logic configured to generate and present application pages, web pages, and/or various other data to users accessing the customer issuer computing system 112 over the network 116.

The transfer service computing system 114 is controlled by, managed by, owned by, and/or otherwise associated with a transfer service entity (e.g., Zelle®) that is configured to enable real-time or nearly real-time transfers. As described herein and in one embodiment, the “transfer” is a payment or fund/resource transfer. However, the present disclosure is also applicable with other types of transfers, such as the secure transfer of information (e.g., documents). The payment or fund transfer may include electronic or digital fund transfers.

In some instances, the transfer service entity may be a financial institution or other entity that supports transfers across multiple different entities (e.g., across different financial institutions). In some instances, the transfer service entity may, for example, be an entity that is formed as a joint venture between banks and/or other entities that send and receive funds using the computing environment 100. As another example, the transfer service entity may be a third-party vendor. As still another example, the transfer service entity may be provided by one of the provider institutions, such that the provider institution performs both the operations described herein as being performed by the merchant acquirer computing systems 110 or the customer issuer computing system 112 and the operations described herein as being performed by the transfer service computing system 114.

The transfer service computing system 114 is configured, in various embodiments, to provide (e.g., through its own client application or through integration with a client application of another entity, such as one of the client applications 122 or the client applications 126) at least some of the functionality depicted in the figures and described herein (e.g., enabling transfers between customer accounts held by the customer issuer and merchant accounts held by the merchant acquirer). For example, in some instances, the transfer service entity provides or hosts a web portal provided for an online community of individuals and/or commercial entities to obtain usernames/login IDs or otherwise become registered members to enable real-time or nearly real-time transfers.

In some instances, as discussed above, at least some of the functionality performed by the transfer service computing system 114 is integrated within various banking applications (e.g., the client applications 122 and/or the client applications 126) provided by the merchant acquirer computing system 110 and/or the customer issuer computing system 112 to the customer device 102. For example, in some instances, the transfer service computing system 114 includes one or more APIs that securely communicate with various components of the computing environment 100 and allow for various functionality performed by the transfer service computing system 114 to be embedded within the client applications 122 and/or the client applications 126 provided to the customer device 102 and/or the merchant computing system 104.

In some embodiments, transfer service computing system 114 may, for example, comprise one or more servers, each with one or more processing circuits including one or more processors configured to execute instructions stored in one or more memory devices, send and receive data stored in the one or more memory devices, and perform other operations to implement the methods and functionalities described herein. Although not specifically shown, it will be appreciated that the transfer service computing system 114 may include a network interface circuit, various databases, an account processing circuit, and other circuits in the same or similar manner to the other components of computing environment 100. In some instances, the network interface circuit may include user interface program logic configured to generate and present application pages, web pages, and/or various other data to users accessing the transfer service computing system 114 over the network 116.

In some embodiments, the transfer service computing system 114 includes a transfer processing circuit 142 that is configured to enable real-time or near real-time transfers between registered users of the transfer service. In some instances, various providers (e.g., the merchant acquirer associated with the merchant acquirer computing system 110 and/or the customer issuer associated with the customer issuer computing system 112) may opt into the transfer service to allow their customers (e.g., the customer associated with the customer device 102, the merchant associated with the merchant computing system 104) to register their accounts for the transfer service. In some instances, opting into the transfer service may include the corresponding providers accepting various terms and conditions for allowing the transfer service to enable transfers between accounts held by different providers.

Once the providers have opted into the transfer service, the providers' customers are able to register for and utilize the transfer service provided by the transfer service computing system 114. For example, in some instances, during a registration process, the transfer service computing system 114 is configured to receive one or more desired transfer service identifiers (e.g., a Zelle® identifier), such as a phone number, an e-mail address, an alphanumeric tag, another token, etc., to be associated with a customer (e.g., the customer associated with the customer device 102 and/or the merchant associated with the merchant computing system 104) registering for the transfer service. During the registration process, the transfer service computing system 114 is further configured to receive various account information (e.g., a bank routing number, a bank account number) and identifying information (e.g., a name, a phone number, an e-mail address, a physical address) associated with the customer to be linked to the corresponding received desired transfer service identifier(s) for registering the customer with the transfer service.

Accordingly, the transfer service computing system 114 is configured to receive a registration request (e.g., from the customer device 102 and/or the merchant computing system 104) to register a particular account of the user (e.g., an account held by the merchant or customer issuer stored within the merchant acquirer account database 134 or the customer issuer account database 140) for the transfer service. Upon receiving the registration request, the transfer service computing system 114 is configured to store the transfer service identifier, the account information, and the identifying information for the user (e.g., the customer and/or the merchant) within an account database 144 and to link the transfer service identifier to the account information and the identifying information within the account database 144 to register the user (e.g., the customer and/or the merchant) with the transfer service.

Once the transfer service identifier, the account information, and the identifying information for the user (e.g., the customer and/or the merchant) have been stored and linked within the account database 144, the transfer processing circuit 142 is configured to, upon receipt of a transfer request (e.g., received from the customer device 102 and/or the merchant computing system 104), query the account database 144 to retrieve the corresponding account information and identifying information associated with sender and recipient (e.g., customer and merchant) transfer service identifiers included in the requested transfer. Once the corresponding account information is successfully retrieved by the transfer processing circuit 142, the transfer processing circuit 142 is configured to initiate a transfer (e.g., of funds) from an account associated with the sender (e.g., the customer) to an account associated with the recipient (e.g., the merchant).

In some embodiments, the transfer service computing system 114 further includes an account database 144. The account database 144 stores transfer service identifiers, corresponding account information, and corresponding identifying information for various transfer service accounts that are maintained by the transfer service on behalf of its customers. The account database 144 is configured to be used by the transfer processing circuit 142 to enable the real-time or near real-time transfers discussed above.

Further, although not specifically shown, it will be appreciated that the transfer service computing system 114 may similarly include various I/O devices (e.g., similar to I/O device(s) 118 and/or I/O device(s) 128)), a network interface circuit (e.g., similar to the network interface circuit 120 and/or network interface circuit 130), client applications (e.g., similar to client applications 122, the client applications 126, and/or the client applications 132), and/or other circuits in the same or similar manner to the other components of computing environment 100.

With an example structure of the computing environment 100 being described above, example processes performable by the computing environment 100 (or components/systems thereof) will be described below. It should be appreciated that the following processes are provided as examples and are in no way meant to be limiting. Additionally, various method steps discussed herein may be performed in a different order or, in some instances, completely omitted. These variations have been contemplated and are within the scope of the present disclosure.

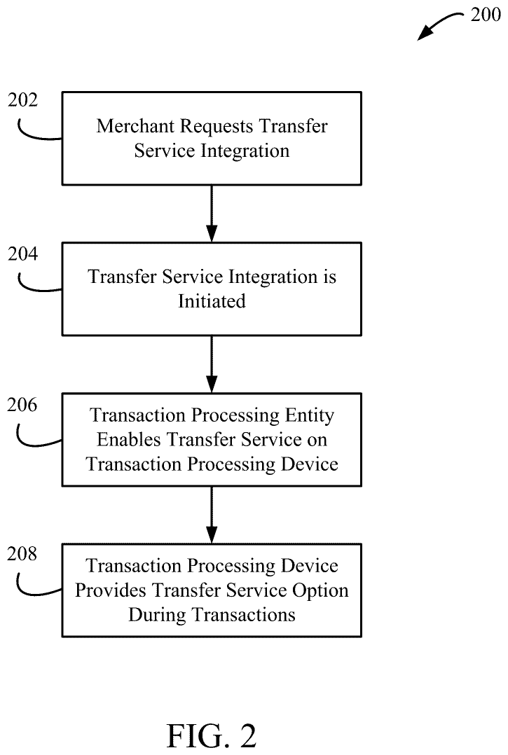

Referring to FIG. 2, a flow diagram of a method 200 for integrating transfer service functionality into a transaction processing device at a point of sale associated with a merchant is shown, according to an example embodiment. Various operations of the method 200 may be conducted by various systems and/or components of the computing environment 100 (e.g., the customer device 102, the merchant computing system 104, the transaction processing device 106, and the transaction processing computing system 108, the merchant acquirer computing system 110, the customer issuer computing system 112, and/or the transfer service computing system 114). It should be understood that the processes or steps shown in method 200 may be performed in another order than depicted, that two or more depicted processes may be performed concurrently, and/or that one or more additional processes may be added to the method 200 without departing from the spirit and scope of the method 200.

As shown, the method 200 begins with a merchant associated with the merchant computing system 104 requesting a transfer service integration, at step 202. In some instances, the transfer service integration is performed via the service integration circuit 138 of the merchant acquirer computing system 110. Accordingly, in these instances, the merchant requests the transfer service integration for the transaction processing device 106 (e.g., located at a point of sale of the merchant) by transmitting a transfer service integration request to the merchant acquirer computing system 110. In some instances, the transfer service integration request is transmitted to the merchant acquirer computing system 110 by the merchant computing system 104. In some instances, the transfer service integration request is transmitted to the merchant acquirer computing system 110 by the transaction processing device 106 (e.g., when the transaction processing device 106 is implemented as part of or is otherwise connected to the merchant computing system 104).

However, it should be appreciated that, in some instances, any of the transaction processing computing system 108, the customer issuer computing system 112, and/or the transfer service computing system 114 may be similarly configured to perform the transfer service integration (e.g., via a circuit similar to the service integration circuit 138). Accordingly, in these instances, the transfer service integration request would be sent to the corresponding computing system configured to perform the transfer service integration.

In some instances, the transfer service integration request may include a transaction processing device identifier identifying the transaction processing device 106, a transaction processing entity identifier identifying the transaction processing entity associated with the transaction processing computing system 108, a merchant transfer service identifier of the merchant that is registered with the transfer service provided by the transfer service entity associated with the transfer service computing system 114, and a transfer service identifier identifying the transfer service entity associated with the transfer service computing system 114.

For example, in some instances, the transaction processing device identifier, the transaction processing entity identifier, the merchant transfer service identifier, and/or the transfer service identifier may be stored within the transaction processing device 106 and/or the merchant computing system 104. Accordingly, the transaction processing device 106 and/or the merchant computing system 104 may access the stored identifiers and provide the identifiers to the merchant acquirer computing system 110 to allow for identification of the appropriate transaction processing device (e.g., the transaction processing device 106), transaction processing entity (e.g., the transaction processing entity associated with the transaction processing computing system 108), merchant (e.g., the merchant associated with the merchant computing system 104), and transfer service entity (e.g., the transfer service entity associated with the transfer service computing system 114) for the transfer service integration.

Once the transfer service integration has been requested, the transfer service integration is then initiated, at step 204. For example, in response to the merchant acquirer computing system 110 (or the system performing the transfer service integration) receiving the transfer service integration request, the merchant acquirer computing system 110 (or the system performing the transfer service integration) then identifies the transaction processing computing system 108 using the transaction processing entity identifier and provides various transfer service information associated with the merchant to the transaction processing computing system 108. For example, in some instances, the transaction processing entity identifier may be used to query a database (e.g., the merchant acquirer account database 134) storing information pertaining to a variety of known transaction processing entities (e.g., Square®, Clover®) to identify the transaction processing entity associated with the transaction processing computing system 108 and transaction processing device 106. In some instances, the transfer service information includes both the transaction processing device identifier identifying the transaction processing device 106 and the transfer service identifier of the merchant that is registered with the transfer service. It will be appreciated that, if the transaction processing computing system 108 is performing the transfer service integration, the transaction processing computing system 108 will already have all of the necessary transfer service information.

In some instances, in response to the merchant acquirer computing system 110 (or the system performing the transfer service integration) receiving the transfer service integration request, the merchant acquirer computing system 110 (or the system performing the transfer service integration) additionally identifies the transfer service computing system 114 using the transfer service identifier. For example, in some instances, the transfer service identifier may be used to query a database (e.g., the merchant acquirer account database 134) storing information pertaining to a variety of known transfer service entities (e.g., Zelle®) to identify the transfer service entity associated with the transfer service computing system 114. The merchant acquirer computing system 110 then provides instructions to the transfer service computing system 114 instructing the transfer service computing system 114 to perform the various functionalities described herein to enable the transaction processing device 106 to implement the transfer service functionalities (e.g., providing a transfer completion notification to the transaction processing device 106 upon completion of corresponding transfers).

Once the transaction processing computing system 108 has received the various transfer service information, the transaction processing entity can enable various transfer service functionality on the transaction processing device 106, at step 206. For example, in some instances, the transaction processing computing system 108 provides the merchant transfer service identifier to the transaction processing device 106 and generates and transmits an update to an application of the transaction processing device 106 (e.g., one of the client applications 132) to enable the transfer service functionality. For example, the update generated and transmitted to the transaction processing device 106 may include a new graphical user interface (e.g., graphical user interface 400) including a new selectable transaction option corresponding to the transfer service to be shown to customers during transactions and instructions to perform the various functions described herein to enable the transfer service functionality. Furthermore, in some instances, the update generated and transmitted to the transaction processing device 106 may include secondary graphical user interface (e.g., graphical user interface 500) and instructions to either generate an embedded code (e.g., scannable code 502) by embedding the merchant transfer service identifier and various transaction information (e.g., a price, a purchase list, a transaction identifier, etc.) within the embedded code to be scanned by a user device (e.g., customer device 102).

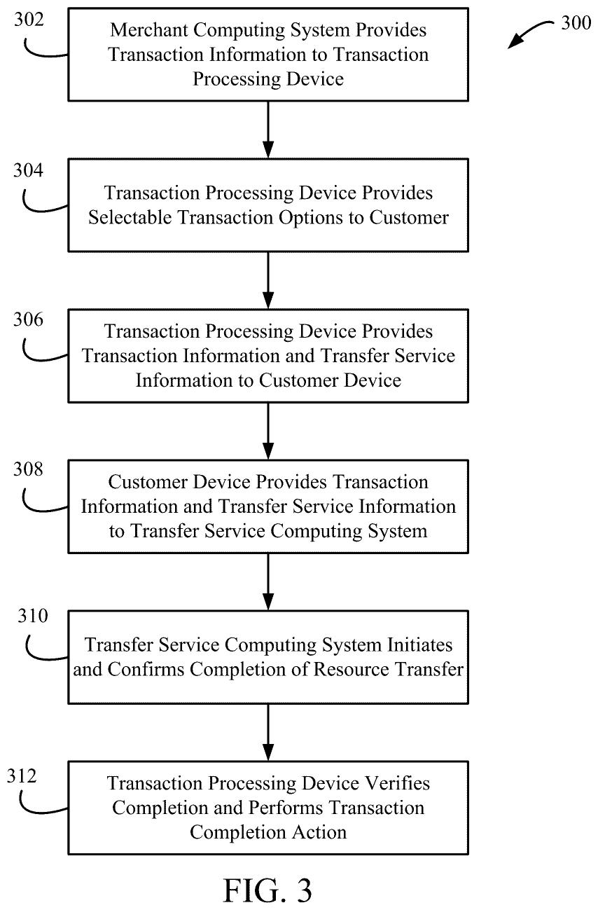

With the transfer service functionality enabled on the transaction processing device 106, the transaction processing device 106 then provides the selectable transaction option corresponding to the transfer service during transactions using the transaction processing device 106 at the point of sale, at step 208, as will be described in detail below, with reference to FIG. 3.

Accordingly, in some instances, by performing the transfer service integration, the merchant acquirer computing system 110 (or the system that is performing the transfer service integration) creates an integrated platform (e.g., accessible via one or more of the client applications 122, the client applications 126, and/or the client applications 132) that allows for the various components of the computing environment 100 to securely communicate with each other to perform the functionalities described herein.

For example, in some instances, to enable the various functionalities described herein, the merchant acquirer computing system 110 (or the system that is performing the transfer service integration) links or otherwise creates associations between various accounts held by the merchant (e.g., an account with the transaction processing entity associated with the transaction processing device 106, an account with the merchant acquirer associated with the merchant acquirer computing system 110, an account with the transfer service associated with the transfer service computing system 114) and stores corresponding access credentials for each account such that information and/or functionalities associated with each account and/or each service can be accessed via a single integrated platform via a single application, such as, for example, one of the client applications 126 provided to the merchant computing system 104 from the merchant acquirer computing system 110. For example, using the access credentials for each separate account, the merchant acquirer computing system 110 can provide authorized access to and implement various functionalities associated with the merchant's accounts associated with each separate entity into one application (e.g., one integrated platform), such that the merchant can, for example, update/modify various functionalities of the transaction processing device 106 (e.g., update/modify graphical user interfaces and/or options presented to customers), review transaction history associated with their transfer service account (e.g., sold items and services, revenue generated via sales), and/or perform various banking functions associated with their financial account held at the merchant acquirer institution.

In some instances, the client application 126 providing the single integrated platform described herein further allows for the merchant to configure various settings associated with the transaction processing device 106. For example, in some instances, the merchant may be able to modify or otherwise control how customers perform transactions with the merchant (e.g., whether or not to allow for transfer service transactions via the transaction processing device 106) and/or how customers receive transaction information (e.g., receipts, displayed information, etc.).

Referring now to FIG. 3, a flow diagram of a method 300 for utilizing a transfer service to complete a transaction at a point of sale associated with a merchant using a transaction processing device, according to an example embodiment. Various operations of the method 300 may be conducted by the computing environment 100 (e.g., the customer device 102, the merchant computing system 104, the transaction processing device 106, and the transaction processing computing system 108, the merchant acquirer computing system 110, the customer issuer computing system 112, and/or the transfer service computing system 114). It should be understood that the processes or steps shown in method 300 may be performed in another order than depicted, that two or more depicted processes may be performed concurrently, and/or that one or more additional processes may be added to the method 300 without departing from the spirit and scope of the method 300.

As shown, the method 300 begins with a merchant associated with the merchant computing system 104 providing transaction information to the transaction processing device 106, at step 302. For example, in some instances, a customer (e.g., associated with the customer device 102) initiates a transaction to purchase goods or services at a merchant point of sale. Accordingly, a user of the merchant computing system 104 may scan the customer's items or input the customer's intended purchase into the merchant computing system 104, and the merchant computing system 104 may communicate various transaction information to the transaction processing device 106 to allow for the transaction processing device 106 to process the transaction on behalf of the merchant. In some instances, the transaction processing device 106 can be implemented within and/or otherwise communicatively connected with the merchant computing system 104 via one or more secure local networks using encryption and/or various other security features to ensure that transaction information transmitted between the merchant computing system 104 and the transaction processing device 106 is not intercepted and/or otherwise tampered with. For example, the transaction information may include a payment or purchase amount, a transaction identifier (e.g., a reference number or code associated with the transaction), a transaction processing device identifier identifying the transaction processing device 106, purchase details (e.g., a list of what is being purchase), etc.

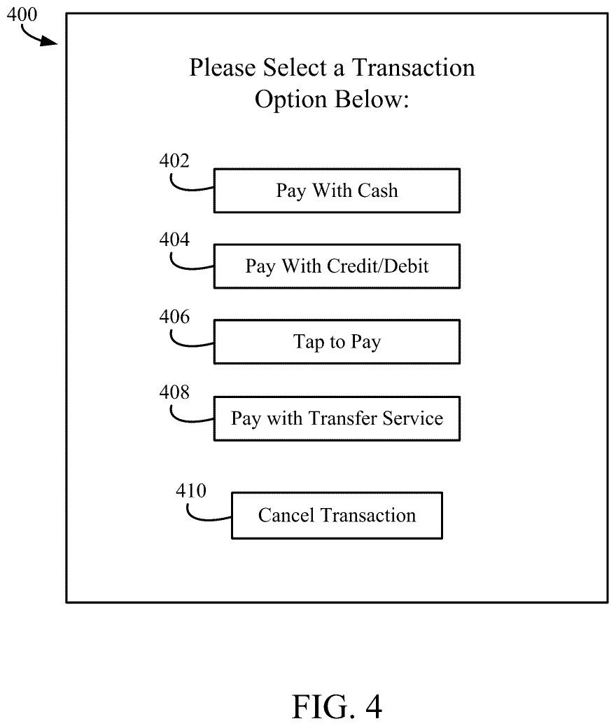

In response to receiving the transaction information from the merchant computing system 104, the transaction processing device 106 then provides a plurality of selectable transaction options to the customer, at step 304. For example, as shown in FIG. 4, the transaction processing device 106 generates and/or displays a graphical user interface 400 configured to allow for the customer to select from a plurality of transaction options. As illustrated, in some instances, the plurality of transaction options includes a cash option 402, a credit/debit option 404, a tap-to-pay option 406, and a transfer service option 408. Accordingly, the customer is allowed to select the transfer service option 408 to pay for or otherwise complete the transaction using the transfer service. In some instances, the graphical user interface 400 may further include a cancel button 410 configured to allow the customer to cancel the transaction.

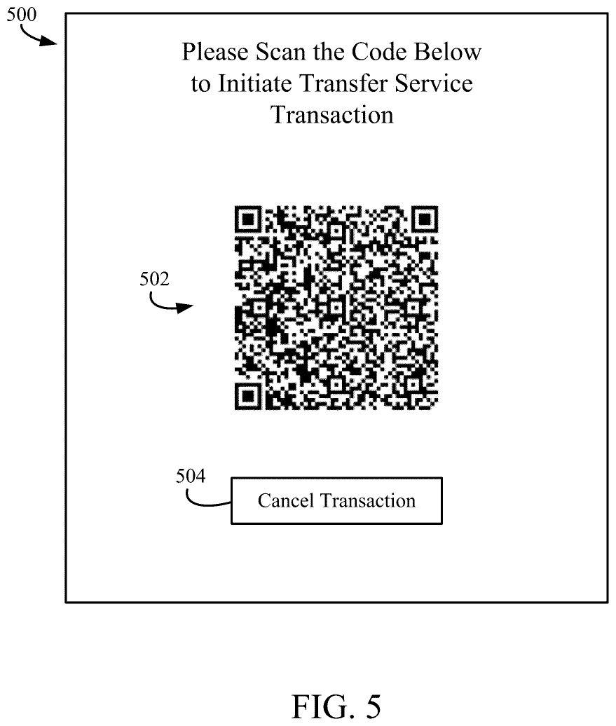

With reference again to FIG. 3, once the customer has selected the transfer service option 408 to pay for or otherwise complete the transaction using the transfer service, the transaction processing device 106 then provides the transfer service information (e.g., the merchant identifier) and the transaction information to the customer device 102, at step 306. For example, as shown in FIG. 5, the transaction processing device 106 may display a graphical user interface 500 including a scannable code 502 and a transaction cancelation option 504 to the customer.

In some instances, the scannable code 502 has the transfer service information and the transaction information embedded therein, as well as instructions for initiating a transfer service resource transfer (e.g., a uniform resource locator (URL) associated with the transfer service). Accordingly, in some instances, the customer may use the customer device 102 to scan the scannable code 502 and to retrieve the transfer service information, the transaction information, and the instructions for initiating the transfer service resource transfer. As illustrated, in some instances, the scannable code 502 is a quick-response (QR) code. However, in other instances, the scannable code 502 can be any other suitable type of code.

In some other instances, instead of (or in addition to) the scannable code 502, the graphical user interface 500 may include a message prompting the customer to tap or otherwise bring the customer device 102 into proximity with the transaction processing device 106. Accordingly, the customer may tap or otherwise bring the customer device into proximity with the transaction processing device 106 to have the transfer service information, the transaction information, and the instructions for initiating the transfer service resource transfer transmitted to the customer device 102 via a wireless communication, such as a short-range wireless communication (e.g., near-field communication).

Once the customer device 102 has received the transfer service information, the transaction information, and the instructions for initiating the transfer service resource transfer, the customer device 102 then initiates the resource transfer by providing the transfer service information and the transaction information to the transfer service computing system 114, at step 308. For example, in some instances, the customer device 102 may automatically transmit the transfer service information (e.g., the merchant identifier, a customer identifier of the customer registered with the transfer service) and the transaction information (e.g., the payment amount, the various items or services purchased, etc.) to the transfer service computing system 114 in response to scanning the scannable code 502 or receiving the wireless communication from the transaction processing device 106 (e.g., based on the instructions for initiating the transfer service resource transfer).

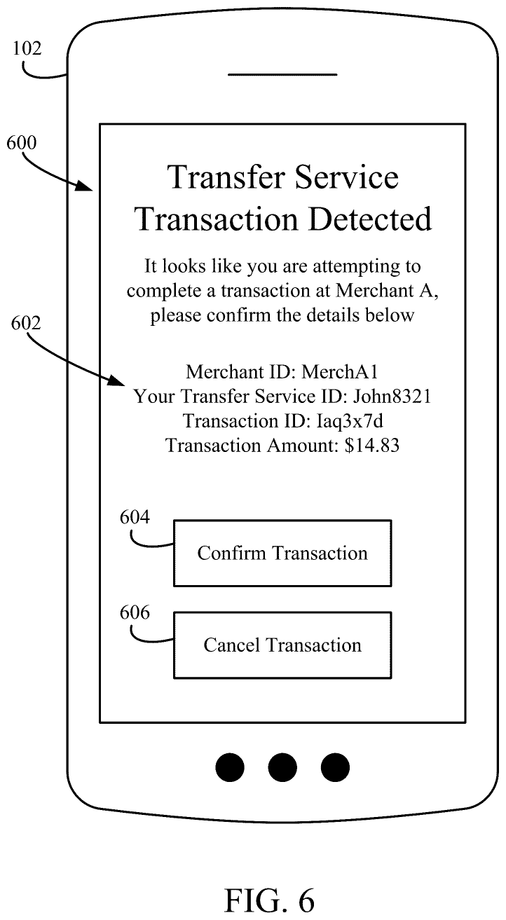

In some other instances, the customer device 102 may transmit the transfer service information and the transaction information to the transfer service computing system 114 upon the customer confirming that they wish to proceed with the resource transfer. For example, referring now to FIG. 6, the customer device 102 may generate or display a graphical user interface 600 indicating that the customer is potentially attempting to complete a transaction at the merchant and requesting that the customer confirm various transfer details 602 associated with the potential resource transfer. For example, the transfer details 602 may include the merchant identifier associated with the transfer service, the customer identifier associated with the transfer service (e.g., stored within the customer device 102 during a registration process with the transfer service), the transaction identifier, the transaction amount, etc. The graphical user interface 600 further includes a transaction confirmation button 604 and a transaction cancelation button 606. Accordingly, upon reviewing the transfer details, the customer may confirm the resource transfer by clicking the transaction confirmation button 604, which triggers the customer device 102 to send the transfer service information and the transaction information to the transfer service computing system 114.

In response to receiving the transfer service information and the transaction information, the transfer service computing system 114 initiates and confirms completion of the resource transfer, at step 310. For example, the transfer service computing system 114 utilizes the merchant identifier and the customer identifier to identify both a merchant transfer service account and a customer transfer service account stored in the account database 144 and registered with the transfer service. The transfer service computing system 114 then utilizes financial account information from each of the registered merchant and customer transfer service accounts to initiate a transfer of resources corresponding to the payment amount from a customer financial account held at or otherwise maintained at the customer issuer associated with the customer issuer computing system 112 to a merchant financial account held at or otherwise maintained at the merchant acquirer associated with the merchant acquirer computing system 110.

Beneficially, the transaction information provided to the transfer service computing system 114 may be associated with the customer's and/or merchant's accounts registered with the transfer service and stored within the account database 144. Accordingly, unlike traditional transfer service records, which may include an indication of the sender, the recipient, the amount transferred, and potentially a user-added note describing the transfer, the integration of the transaction information from the merchant computing system 104 and/or the transaction processing device 106 allows for continuous and automated monitoring of what is purchased (e.g., the specific items and/or services purchased as opposed to simply the name of the recipient/sender and the amount) for personal tracking (e.g., tracking purchases and amount spent by purchase category type of goods and/or services purchased using the transfer service) and/or inventory tracking for the merchant and/or customer.

Upon completion of the transfer of resources, the transfer service computing system 114 then identifies the transaction processing device 106 using the transaction processing device identifier and transmits a notification to the transaction processing device 106 confirming that the resource transfer has been completed. For example, the notification may include a confirmation payment amount, a confirmation transaction identifier, and/or a confirmation customer identifier. In some instances, the transfer service computing system 114 may be configured to transmit the various confirmation information to the transaction processing device 106 via a secure network and/or using encrypted communications (e.g., provided via the integrated platform enabled using the merchants various access credentials, as described herein), such that the confirmation information is securely provided to the transaction processing device 106, thereby ensuring that the transaction confirmation is not fraudulent. In some instances, the transfer service computing system 114 is configured to transmit the various confirmation information to the merchant acquirer computing system 110, which is then configured to relay the confirmation information to the transaction processing device 106 (e.g., via the integrated platform).

In response to receiving the notification confirming that the resource transfer has been completed, the transaction processing device 106 then verifies the transaction completion and performs a transaction completion action, at step 312. For example, in some instances, the transaction processing device 106 may verify the transaction completion by verifying that the confirmation transaction identifier matches the transaction identifier associated with the transaction being conducted. In some instances, the transaction processing device 106 may verify the transaction completion by verifying that the confirmation payment amount matches the payment amount associated with the transaction being conducted. In some instances, the transaction processing device 106 may verify the transaction completion by verifying that the confirmation customer identifier matches the customer identifier of the customer associated with the transaction being conducted.

It should be appreciated that, in some instances, the transaction confirmation information (e.g., the confirmation payment amount, the confirmation transaction identifier, and/or the confirmation customer identifier) may be communicated to and verified by the transaction processing device 106 in real-time or near real-time to allow for near-instantaneous verification of the completed transaction, thereby enabling the transfer service transfer to be securely utilized in point-of-sale transactions with the merchant.

In some instances, upon verifying the transaction completion, the transaction completion action may include the transaction processing device 106 providing a receipt to the customer. For example, in some instance, the transaction processing device 106 includes a printing device configured to print physical receipts for providing to the customer. In some instances, the transaction processing device 106 may additionally or alternatively be configured to transmit a copy of the receipt to the customer device 102 or another device associated with the customer (e.g., a short-range wireless communication, a short message service (SMS) or text message, an email, etc.) via the network interface circuit 130 or another near-field communication circuit of the transaction processing device 106. In some other instances, the transaction processing device 106 may additionally or alternatively be configured to display a transaction completion notification to the customer (e.g., via a display of one of the I/O devices 128) that includes a receipt or other transaction completion details. In some instances, the transaction completion notification and/or receipt may include a transaction amount, a merchant identifier, a list of items or services purchased, a transaction identifier, etc.

It should be appreciated that, while various communications have been described above as being between specific system components, in some instances, various communications (e.g., between the merchant computing system 104, the transaction processing device 106, the merchant acquirer computing system 110, and the transfer service computing system 114) may each be automatically conducted by, enabled by, or otherwise facilitated via the integrated platform accessible via a corresponding application on each system or device (e.g., the client applications 126, the client applications 132, or other similar applications).

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively, or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud-based processor). Alternatively, or additionally, the one or more processors may be internal and/or local to the apparatus. In this regard, a given circuit or components thereof may be disposed locally (e.g., as part of a local server, a local computing system) or remotely (e.g., as part of a remote server such as a cloud-based server). To that end, a “circuit” as described herein may include components that are distributed across one or more locations.

An exemplary system for implementing the overall system or portions of the embodiments might include a general-purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general-purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A method comprising:
receiving, by a transaction processing device associated with a point of sale of a merchant, transfer service information associated with the merchant, the transfer service information including a merchant identifier for the merchant and associated with a transfer service provided by a transfer service entity;
receiving, by the transaction processing device, transaction information associated with a transaction at the point of sale from a merchant computing system of the merchant, the transaction information including a transaction identifier identifying the transaction;
providing, by the transaction processing device, the transfer service information and the transaction information to a customer device of a customer during the transaction at the point of sale;
receiving, by the transaction processing device, a notification that a transfer of resources corresponding to the transaction has been completed, the notification including a confirmation transaction identifier;
verifying, by the transaction processing device, that the transaction has been completed based on the transaction identifier matching the confirmation transaction identifier; and
in response to verifying that the transaction has been completed, performing, by the transaction processing device, a transaction completion action.

2. The method of claim 1, further comprising:
providing, by the transaction processing device, the customer with a plurality of selectable transaction options including a selectable transaction option that is selectable by the customer to utilize the transfer service to complete the transaction; and
receiving, by the transaction processing device, a selection of the selectable transaction option,
wherein the transfer service information and the transaction information are provided to the customer device in response to receiving the selection of the selectable transaction option.

3. The method of claim 1, wherein providing the transfer service information and the transaction information to the customer device comprises displaying a scannable code that is scanned by the customer device, the scannable code having the transfer service information and the transaction information embedded therein.

4. The method of claim 1, wherein providing the transfer service information and the transaction information to the customer device comprises transmitting the transfer service information and the transaction information to the customer device.

5. The method of claim 4, wherein transmitting the transfer service information and the transaction information to the customer device is performed via a short-range communication.

6. The method of claim 1, wherein the transaction completion action comprises providing a receipt to the customer.

7. The method of claim 1, wherein the transaction completion action comprises displaying a transaction completion notification.

8. The method of claim 1, wherein the transaction information includes a payment amount, and the notification further includes a confirmation payment amount, and verifying that the transaction has been completed is further based on the payment amount matching the confirmation payment amount.

9. The method of claim 1, wherein the transfer service information is received by the transaction processing device during a transfer service integration requested by the merchant, the transfer service integration enabling the transaction processing device to complete transactions using the transfer service, and wherein the transaction occurs after the transfer service integration has been completed.

10. The method of claim 1, wherein at least one of the transfer service information or the notification is received from a transfer service computing system associated with the transfer service entity.

11. A method comprising:
providing, by a provider computing system of a provider, a graphical user interface including transfer service information associated with a merchant to a transaction processing device associated with a point of sale of the merchant, the transfer service information including a merchant identifier for the merchant and associated with a transfer service provided by a transfer service entity, the graphical user interface including the transfer service information embedded within a scannable code;
receiving, by the provider computing system, the transfer service information and transaction information from a customer device of a customer, the transaction information corresponding to a transaction using the transaction processing device at the point of sale of the merchant; and
in response to receiving the transfer service information and the transaction information, initiating, by the provider computing system, a transfer of resources from a customer account of the customer to a merchant account of the merchant based on the merchant identifier and the transaction information.

12. The method of claim 11, wherein the transaction information includes a payment amount and a transaction identifier identifying the transaction, and the method further comprises transmitting, by the provider computing system upon completion of the transfer of resources, a notification to the transaction processing device of the merchant, the notification including at least one of the payment amount or the transaction identifier and confirming that the transfer of resources has been completed.

13. The method of claim 11, further comprising receiving, by the provider computing system, a transfer service integration request from a merchant computing system associated with the merchant, the transfer service integration request requesting integration of one or more functionalities of the transfer service into the transaction processing device at the point of sale of the merchant,
wherein the transfer service information is provided to the transaction processing device in response to the transfer service computing system receiving the request to receiving the transfer service integration request.

14. The method of claim 13, wherein providing the transfer service information to the transaction processing device comprises transmitting the transfer service information to the transaction processing device via a transaction processing computing system that manages a plurality of transaction processing devices for a plurality of merchants.

15. The method of claim 11, wherein the provider and the transfer service entity are separate entities.

16. A transaction processing device comprising:
one or more processing circuits including one or more processors and one or more memories having instructions stored thereon that, when executed by the one or more processors, cause the one or more processing circuits to:
receive transfer service information of a merchant associated with the transaction processing device, the transfer service information including a merchant identifier for the merchant and associated with a transfer service provided by a transfer service entity;
receive transaction information associated with a transaction at a point of sale from a merchant computing system of the merchant, the transaction information including a transaction identifier identifying the transaction;
provide a customer with a plurality of selectable transaction options including a selectable transaction option that is selectable by the customer to utilize the transfer service to complete the transaction;
in response to receiving a selection of the selectable transaction option, provide the transfer service information and the transaction information to a customer device of the customer;
receive a notification indicating that a transfer of resources corresponding to the transaction has been completed, the notification including a confirmation transaction identifier; and
verify that the transaction has been completed based on the transaction identifier matching the confirmation transaction identifier.

17. The transaction processing device of claim 16, wherein providing the transfer service information and the transaction information to the customer device comprises displaying a scannable code that is scanned by the customer device, the scannable code having the transfer service information and the transaction information embedded therein.

18. The transaction processing device of claim 16, wherein providing the transfer service information and the transaction information to the customer device comprises transmitting the transfer service information and the transaction information to the customer device via a short-range communication.

19. The transaction processing device of claim 16, wherein the instructions further cause the one or more processing circuits to, in response to receiving the notification, perform, by the transaction processing device, a transaction completion action.

20. The transaction processing device of claim 19, wherein the transaction completion action comprises at least one of providing a receipt to the customer or displaying a transaction completion notification.
